(19) United States
(12) Patent Application Publication
(10) Pub. No.: US 2007/0131281 A1
(43) Pub. Date: Jun. 14, 2007

(54) UNDERGROUND FUEL TANK VENT VALVE

(75) Inventor: Peter E. Manger, Cincinnati, OH (US)

Correspondence Address: WOOD, HERRON & EVANS, LLP, 2700 CAREW TOWER, 441 VINE STREET, CINCINNATI, OH, 45202, US

(73) Assignee: DELAWARE CAPITAL FORMATION, INC., Wilmington, DE (US)

(21) Appl. No.: 11/564,630

(22) Filed: Nov. 29, 2006

Related U.S. Application Data
(60) Provisional application No. 60/749,912, filed on Dec. 13, 2005.

(51) Int. Cl. G05D 7/06

(52) U.S. Cl. 137/487.5

(57) ABSTRACT

A vent valve for a fuel tank includes a valve housing having a first valve mechanism movable between an open and closed position and a second valve mechanism movable between an open and closed position. The first valve mechanism opens to vent the tank at a first design pressure differential between the tank pressure and atmospheric pressure and the second valve mechanism opens to vent the tank at a second design pressure differential that is greater than the first design pressure differential. The first valve mechanism is an electronic valve mechanism and the second valve mechanism is a mechanical valve mechanism. A method of venting a fuel tank includes opening the first valve mechanism to establish fluid communication between the tank and atmosphere at the first design pressure differential and opening the second valve mechanism to establish fluid communication between the tank and atmosphere at the second design pressure differential.

### CROSS REFERENCE TO RELATED APPLICATIONS

This application claims priority to provisional patent application Ser. No. 60/749,912 filed on Dec. 13, 2005, the disclosure of which is expressly incorporated by reference herein in its entirety.

### FIELD OF THE INVENTION

This invention relates to venting of underground fuel tanks and more particularly to improved vents providing more accurate and consistent venting at low pressure differentials, while accommodating high volume vent flow at higher pressure differentials.

### BACKGROUND OF THE INVENTION

Currently, underground fuel tanks are connected to a vent line and an above-surface vent for venting vapors at positive pressures in excess of ambient pressures and for inflow of atmospheric air in the event of a vacuum or negative pressure in the tank. Such pressure differentials may result from thermal expansions and contractions resulting from temperature changes and the like, for example. Tanks are individually vented or a plurality of tanks is connected to a manifold, which is in turn vented to the above-surface vent.

Present day vent valves of mechanical structure are operated by applied pressure differentials at selected cracking pressures. For example, a vent is structured to open mechanically in response to a relative positive pressure, compared to ambient, as low as three inches (± one-half inch) of water column pressure. Moreover, such a vent is also structured to open mechanically in response to a vacuum in the tank at a relative negative pressure, compared to ambient, of eight inches (± two inches) of water column pressure. In addition, where much larger pressures and attendant flow rates are encountered, such as where a tank is filled without operator manipulated venting, the system vent must be capable of opening and passing a certain volumetric flow rate of gas or vapor (e.g., on the order of 7,000 cubic feet per hour at 2 psi). This situation may occur, for example, where an operator fails to connect a vacuum relief line to a delivery truck as the tank is filled. Such a prior valve is disclosed in, for example, commonly assigned U.S. Publication No. 2004/0074538, the disclosure of which is expressly incorporated herein in its entirety by reference.

The prior mechanical vents have served these venting functions well in the past, with consistent performance results in most circumstances. The mechanical nature of their structures, when combined with harsh use environments, however, makes it difficult to consistently control low pressure cracking and sealing in a small number of instances in extreme ranges of use. These circumstances could be detrimental to the function and to the preciseness of the functional repeatability of the valve in certain applications. Specifically and for example, the low positive pressure relief valve has included a weighted piston disposed over a vent port and resting on a seal. The weight of the piston and its face area exposed within the seal are coordinated so the piston is theoretically lifted at the low pressure of about three inches of water column pressure.

Due to the harsh conditions in which the prior valve is used, however, it is very difficult to consistently control the low cracking and sealing desired. Thus, in certain circumstances, a newly manufactured vent valve may easily pass testing upon initial installation, but may not pass at a later time due to environmental and other circumstances. Such a piston also accommodates emergency pressure relief but the differentials are such that opening of the piston under this circumstance is not problematical. Accordingly, while the prior valve has proved very useful, stringent performance regulations make it desirable to provide an improved valve that operates consistently over its entire lifetime where no aberrations in environmental circumstances cause the valve to fall below original performance standards.

Similar concerns exist with the vent valve on the negative or vacuum side, which typically includes a spring-biased poppet. This poppet is disposed in the face of the piston noted above for passing atmospheric air into the vent line upon or in response to the presence of a design negative pressure differential. Thus, for both vent processes, it is desirable to provide an improved valve, which retains the design opening characteristics throughout its anticipated life.

It is accordingly an objective of the invention to provide an improved pressure vent valve that opens and closes within its design range consistently throughout its use.

Another objective of the invention has been to eliminate functional mechanical structures in such a vent valve while retaining a valve which consistently opens and closes within design and regulator mandated parameters.

A further objective is to provide an improvement to the vent valve disclosed in the aforementioned U.S. Publication No. 2004/0074538.

### SUMMARY OF THE INVENTION

To these ends, one embodiment of the invention contemplates a pressure vent valve including an electronic pressure sensor for sensing vent line pressure, which is indicative of the tank pressure. The sensor is operatively coupled to an electronic control, which operates a solenoid valve to vent the line (and therefore the tank) upon and in response to a signal representative of a design positive pressure differential. Opening of the solenoid valve passes gas and/or vapor from the vent line and into the atmosphere through the solenoid valve. Similarly, negative pressure in the vent line is sensed by the pressure sensor and the solenoid valve opened in response to a signal representative of a design negative pressure differential. Opening the solenoid valve allows air to flow into the vent line through the solenoid valve.

An emergency relief valve (but without the vacuum poppet) similar to that disclosed in U.S. Publication No. 2004/0074538 may be retained for emergency venting, i.e., at high positive pressures, as noted above since the pressure and flow rates expected are sufficient to adequately vent excess tank pressure. Optionally, the vacuum poppet may be retained as well for emergency vacuum venting at selected high negative pressures, if desired.

Accordingly, embodiments of the invention contemplates a vent valve for an underground fuel tank which electronically senses pressure and vents a vent line in response to an electrical signal representative of a selected pressure differential. In one embodiment, the invention includes an electronic control and solenoid valve mounted on the vent valve housing. A low voltage electrical power supply connection is disposed proximate to or on the vent line. Once the vent valve is screwed or otherwise coupled to the vent pipe, the electrical power supply is then connected via an appropriate connection to the electronic control. Finally, the control is configured such that when power is supplied to the valve, the vent valve is closed until the operative or design pressure differentials are detected. If power is interrupted, the solenoid valve automatically moves to a vent open condition, thus providing a fail-safe vent valve.

A method of using the vent valve in accordance with the invention contemplates electronically sensing a pressure differential between an underground tank and the atmosphere and electronically initiating opening or closing the vent valve responsive to detection of selected pressure differentials.

Through this structure and method, more consistent venting is provided and an improved vent valve opens and closes more consistently, in response to design range pressures, throughout its operative life.

These and other objects, advantages and features of the invention will become more readily apparent to those of ordinary skill in the art upon review of the following detailed description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is an illustration of the environment in which an embodiment of the invention may be used;

FIG. 2 is a perspective view of an embodiment of a vent valve in accordance with the invention;

FIG. 3 is an exploded view of the embodiment of the vent valve shown in FIG. 2;

FIG. 4 is a cross-section view of the vent valve of FIG. 2 generally taken along lines 4-4; and

FIG. 5 is a schematic showing one form of control in accordance with the invention.

### DETAILED DESCRIPTION

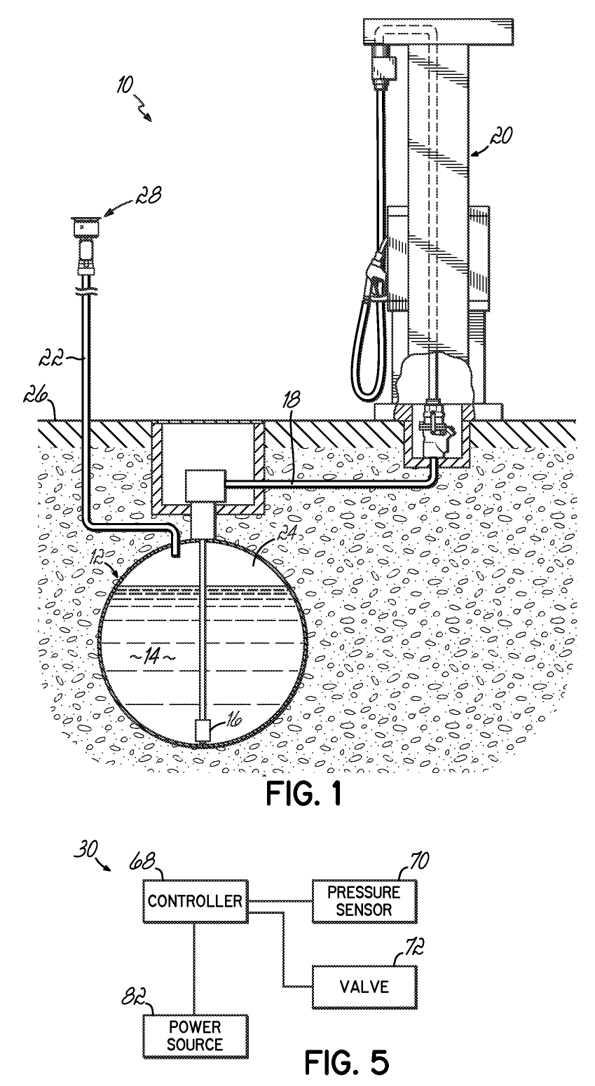

An exemplary fuel dispensing system 10 in accordance with the invention is shown in FIG. 1 and generally includes an underground fuel tank 12 for storing a fuel 14, and a submersible pump 16 located within tank 12 and coupled to a fluid conduit line 18 that transports the fuel 14 under pressure to one or more dispensers 20. The fuel dispensing system 10 also generally includes a vent line 22 that fluidly couples the vapor or ullage space 24 of the tank 12 to the atmosphere above the ground 26. The vent line 22 includes a pressure/vacuum (PV) vent valve 28 that permits fluid flow out of or into the tank 12 under certain design pressure differentials. For instance, if the pressure in tank 12 exceeds atmospheric pressure by a specified amount, the PV vent valve 28 opens to allow fluid, such as fuel vapor, air, etc. in the ullage space 24 to flow out of the tank 12, vent line 22, and to the atmosphere to reduce or equalize the pressure in tank 12. Similarly, if the pressure in the tank 12 falls below atmospheric pressure by a specified amount, i.e., a vacuum is created within the tank 12, the PV vent valve 28 again opens and allows atmospheric air to flow into the vent line 22 and tank 12 to increase or equalize the pressure in tank 12. While the PV vent valve 28 is shown and described herein as being used with an underground fuel tank 12, the invention is not so limited as those of ordinary skill in the art will recognize that the PV vent valve 28 may also be used with an above ground storage tank (not shown).

The pressure differentials at which the PV vent valve 28 opens may be dictated by various regulations. For instance, standard regulations may require that when the tank 12 is under pressure, the PV vent valve 28 open for a positive pressure differential between about two and one-half inches of water column pressure and about 6 inches of water column pressure. In a similar manner, when the tank 12 is under vacuum, standard regulations may require the PV vent valve 28 open for a pressure differential of between about 6 inches of water column pressure and about ten inches of water column pressure. Venting at these design pressure differentials is referred to herein as low pressure venting and may be a result of normal thermal expansion/contraction of the tank 12 and/or fuel 14.

In addition to low pressure venting of the tank 12 described above, the PV vent valve 28 also vents under certain high pressure conditions for various safety considerations as well as to meet UL® ratings. For example, the UL® ratings may require that the PV vent valve 28 open at a pressure differential of about two psi and permit a volume flow rate through the PV vent valve 28 of approximately 7,000 cubic feet of gas or vapor per hour. Emergency venting, however, preferably occurs at design pressure differentials below two psi, which may be considered a maximum pressure differential before emergency venting. Venting at these elevated design pressure differentials is referred to herein as high pressure venting and may be a result of certain emergency conditions.

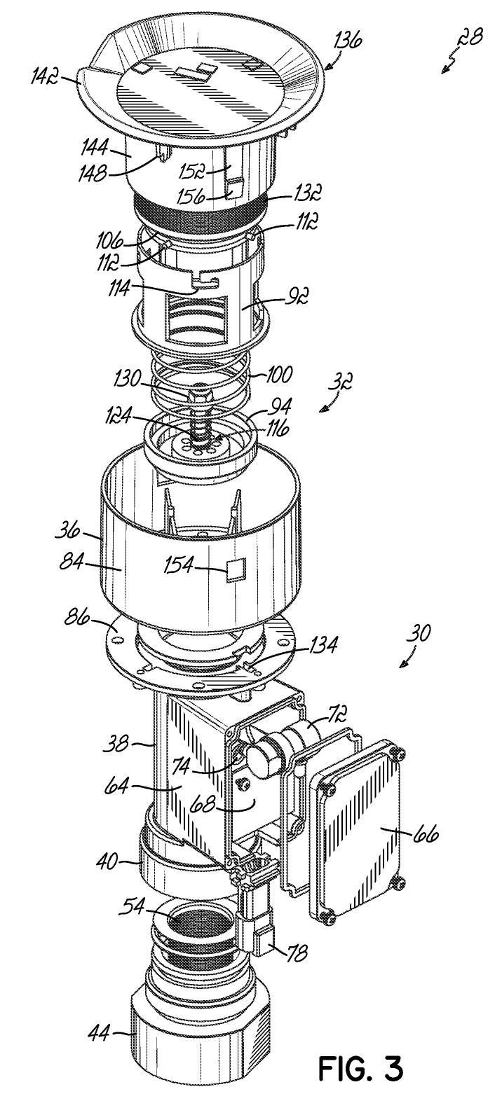

As explained above and described in commonly assigned U.S. Publication No. 2004/0074538, previous PV vent valves are typically designed such that a single valve mechanism operates for both the low pressure venting and high pressure venting using mechanical based valve elements. In one aspect, embodiments of the PV vent valve 28 use two separate valve mechanisms to accomplish the low and high pressure venting. Such a design reduces or eliminates many of the drawbacks associated with previous PV vent valves noted above. To this end, embodiments of the PV vent valve 28 use an electronic valve mechanism 30 to accomplish the low pressure venting while using a mechanical valve mechanism 32 to accomplish the high pressure venting (FIG. 3), as will be described in more detail below.

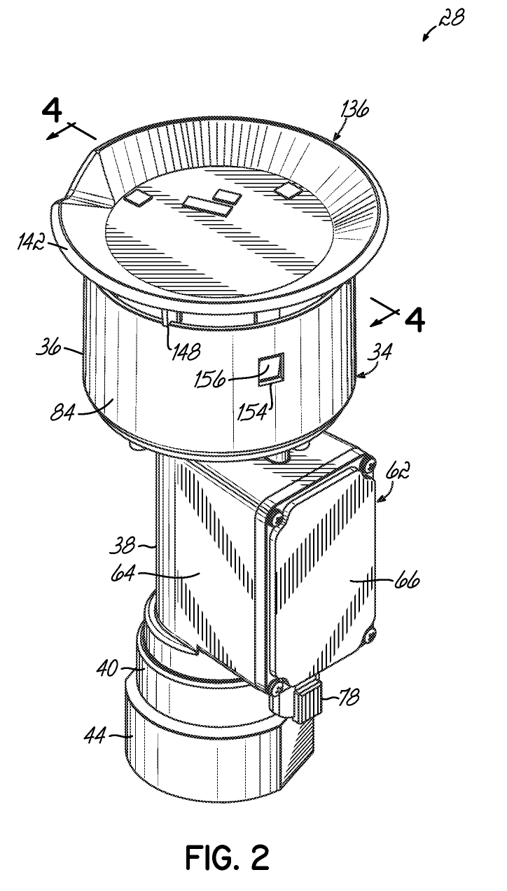

FIGS. 2-4 show an exemplary embodiment of a PV vent valve 28 includes a housing 34 having a proximal portion 36, an intermediate portion 38, a distal portion 40, and a central passage 42 extending between the proximal and distal portions 36, 40. As compared to the valve in U.S. Publication No. 2004/0074538, the intermediate portion 38 is enlarged or lengthened to accommodate the additional structure or features that differentiate PV vent valve 28 from previous vent valves. The proximal portion 36 of the PV vent valve 28 is in fluid communication with the atmosphere and the distal portion 40 is coupled to the end of the vent line 22 (FIG. 1).

The distal portion 40 of housing 34 may be coupled to vent line 22 via an adaptor 44, such as the adaptor shown and described in U.S. Publication No. 2004/0074538. The adaptor 44 includes a proximal end 46 threadedly engaging the distal portion 40 of housing 34. For instance, the proximal end 46 may include exterior threads 48 while the distal portion 40 of housing 34 may include a corresponding set of interior threads 50 such that the respective threads 48, 50 cooperate to couple the adaptor 44 to the distal portion 40 of housing 34. The proximal end 46 may also include a seal, such as an O-ring 52, that seals the adaptor 44 to the housing 34 when the adaptor 44 is coupled thereto. The adaptor 44 may further include a mesh screen filter 54 having a generally cylindrical body that extends within the adaptor 44 and a radially-extending flange that abuts the proximal end 46 of the adaptor 44. The flange is captured between the proximal end 46 of the adaptor 44 and a shoulder 56 in the distal portion 40 of the housing 34 when the adaptor 44 is coupled thereto. The filter 54 provides filtering of the gas or vapor exiting the PV vent valve 28 from the tank 12 and vent line 22 or the air entering the PV vent valve 28 from the atmosphere. The adaptor 44 further includes a distal end 58 that may include a set of interior threads 60 while the end of the vent line 22 may include a corresponding set of exterior threads (not shown) such that the respective threads cooperate to couple the adaptor 44, and thus the PV vent valve 28, to the vent line 22.

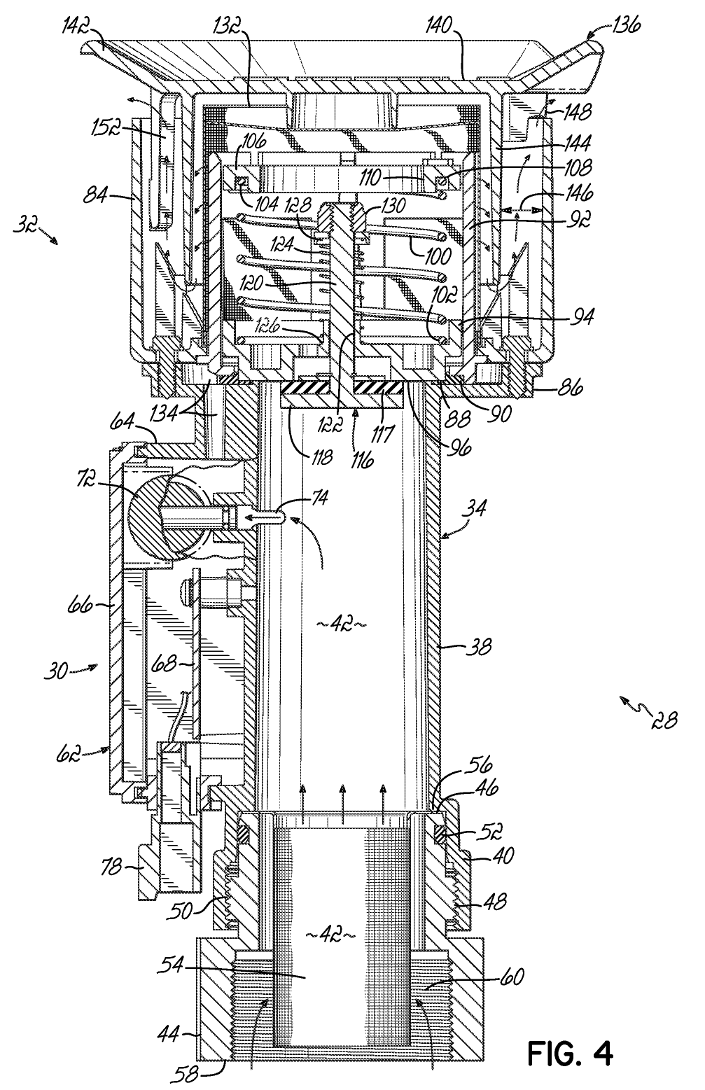

The intermediate portion 38 of the housing 34 includes an enclosure 62 for containing various electronics and valve components for controlling the low pressure venting, collectively referred to herein as the electronic valve mechanism 30. The enclosure 62 includes a base 64 and a removable cover 66 that seals to the base 64 in a water and air-tight manner. Turning momentarily to FIG. 5, the electronic valve control as well as the power and sensing components of the electronic valve mechanism 30 are schematically illustrated. The electronic valve mechanism 30 includes a PC board having various electronic components that collectively operate as a controller 68 (FIG. 4). Those of ordinary skill in the art will recognize a wide range of controllers that may be adapted to operate with embodiments of the invention. A pressure sensor 70, shown schematically in FIG. 5, may be positioned in the enclosure 62, such as on the back side of the PC board, and is in fluid communication with the central passage 42 in the housing 34, such as through a port (not shown) in enclosure 62, for sensing the pressure in vent line 22, which is indicative or representative of the pressure in tank 12. The pressure sensor 70 is operatively coupled to the controller 68 and is capable of generating a signal, which is relayed to the controller 68, that is indicative or representative of the pressure in the tank 12. By way of example, such a pressure sensor 70 may be a pressure transducer. Those of ordinary skill in the art will recognize, however, other pressure sensors that may be used with embodiments of the invention.

The electronic valve mechanism 30 further includes a controllable electronic valve 72 positioned in the enclosure 62 and having an open position wherein fluid may flow through the valve 72, and a closed position wherein fluid is prevented from flowing through the valve 72. The valve 72 is operatively coupled to the controller 68 and is electronically actuated between the open and closed positions using the controller 68. By way of example, one such valve capable of being electronically actuated is a solenoid valve, as is known in the art. However, those of ordinary skill in the art will recognize other such valves that may be used with embodiments of the invention.

The valve 72 is in fluid communication with a first port 74 communicating, for example, through a sidewall of enclosure 62 and into the central passage 42 extending through housing 34 of the PV vent valve 28. The valve 72 further includes a second port (not shown) in fluid communication with the atmosphere. For example, as explained in more detail below, the second port may be in fluid communication with the interior of the enclosure 62 and the interior of the enclosure 62 have a fluid path to atmosphere. In any event, when the valve 72 is open, gas or vapor may flow out of the tank 12, through vent line 22, through the valve 72, and to atmosphere when under positive pressure. Alternately, air may flow from the atmosphere, through the valve 72, through vent line 22, and into the tank 12 when under negative pressure. Because the valve 72 is electronic, the valve may be configured in a fail-safe mode such that if, for example, power to the valve 72 is interrupted, the valve 72 automatically moves to the open position thereby preventing any pressure or vacuum buildup in the tank 12.

The electronic valve mechanism 30 further includes an electrical connector 78 that may be removably coupled to a corresponding connector (not shown) that may be positioned, for example, adjacent the end of the vent line 22. The connector on the vent line 22 is in electrical communication with a power source 82, shown schematically in FIG. 5. In this way, after the PV vent valve 28 has been threadedly engaged with the vent line 22, such as via adaptor 44, the connector 78 on the PV vent valve 28 may be coupled to the connector on the vent line 22 to supply power to the electronic valve mechanism 30. As recognized by those of ordinary skill in the art, other electronic components may be included in the power source 52 and/or as part of the electronic valve mechanism 30 to provide an appropriate level of power, such as a very low voltage power, to the PV vent valve 28. Such components and modifications are considered to be within the scope of the invention.

The electronic valve mechanism 30 operates to provide both the positive and negative low pressure venting of the PV vent valve 28. In operation, the pressure sensor 70 monitors the pressure in the vent line 22 which is in fluid communication with tank 12. The pressure sensor 70 then generates a signal indicative of the pressure in the tank 12 and sends it to the controller 68. The controller 68 receives the signal and determines whether the pressure differential, i.e., the difference between the sensed or detected pressure and atmospheric pressure, is in a range such that low pressure venting is required. To this end, the controller 68 may be configured such that if the detected pressure exceeds atmospheric pressure by a specified amount, such as a design pressure differential between about two and one-half inches of water column pressure and about six inches of water column pressure, the controller 68 sends a signal to the valve 72 to move the valve to the open position. This allows gas or vapor in the tank 12 to vent to atmosphere thereby reducing or equalizing the pressure in tank 12. Once the pressure in tank 12 has been reduced or equalized, the controller 68 sends a signal to the valve 72 to move the valve to the closed position.

In a similar manner, if the controller 68 receives a signal from the pressure sensor 70 that the detected pressure is below atmospheric pressure by a specified amount, such as a design pressure differential between about six inches of water column pressure and about ten inches of water column pressure, the controller 68 sends a signal to the valve 72 to move the valve to the open position. This allows air from the atmosphere to flow into tank 12 thereby reducing or relieving the vacuum inside tank 12. Once the pressure in the tank 12 has been increased or equalized, the controller 68 sends a signal to the valve 72 to move the valve to the closed position. In this way, the electronic valve mechanism 30 accomplishes the low pressure venting of the tank 12 that heretofore had been achieved through mechanical means, but without the disadvantages of the mechanical structures noted above. The components of the electronic valve mechanism 30 may be optimized for the relatively low pressures required by the various regulations, without also being designed for the high pressure safety and UL® requirements. This aspect allows for more precise and reliable low pressure venting.

The PV vent valve 28, however, may also provide for high pressure venting to satisfy various safety considerations and UL® ratings. In one aspect of the invention, the high pressure venting is not accomplished through the electronic valve mechanism 30 used for the low pressure venting, but instead may be accomplished through a separate mechanical valve mechanism 32. In particular, the high pressure venting may be accomplished through a mechanical valve mechanism similar to that used in current PV valves. Such mechanical valve mechanisms are disclosed in commonly assigned U.S. Publication No. 2004/0074538, with the exception that such valve mechanism is now constructed to function only under the high pressure conditions.

The proximal portion 36 of housing 34 is configured as a generally cylindrical hub 84 that couples to the proximal end of intermediate portion 38 via flange 86 and fasteners such as screws. The central passage 42 in the proximal portion 36, e.g., the inner diameter of hub 84, has a cross dimension larger than the cross dimension of the central passage 42 in the intermediate portion 38 so as to define a valve seat 88 between the two portions of the central passage 42. The valve seat 88 is positioned proximal of the first port 74 communicating with the valve 72. The valve seat 88 includes a seal 90, which may be a foamed or elastomeric O-ring. The proximal portion 36 of housing 34 further includes a generally cylindrical inner support 92 that substantially surrounds valve seat 88 and extends in the proximal direction. The inner support 92 may be a separate piece that is secured within the hub 84 during, for example, assembly of the of the PV vent valve 28. Alternately, the inner support 92 may be integrally formed with the hub 84.

A generally cylindrical valve element 94 is positioned within the inner support 92 so that a distal surface or face 96 of the valve element 94 engages the seal 90 on the valve seat 88. In an exemplary embodiment, the valve element 94 is a disc-shaped piston. The valve element 94 is movable between an open position wherein fluid may flow through the mechanical valve mechanism 32, and a closed position wherein fluid is prevented from flowing through the mechanical valve mechanism 32. When the valve element 94 is engaged with the valve seat 88, the mechanical valve mechanism 32 is in a closed position. The mechanical valve mechanism 32 is configured to be in the closed position until a high pressure condition is reached within tank 12. In other words, the mechanical valve mechanism 32 is designed to remain closed during the low pressure conditions which actuate the electronic valve mechanism 30. During emergency situations, however, when a high pressure condition may be encountered, the valve element 94 is separated or moved away from the valve seat 88 to allow fluid to readily move through the mechanical valve mechanism 32.

To prevent the mechanical valve mechanism 32 from moving to the open position during low pressure venting, the valve element 94 may be biased toward the valve seat 88 so as to remain closed. To this end, the valve element 94 may be biased toward the valve seat 88 by a biasing member 100, such as a coil spring. As shown in FIG. 4, the biasing member 100 has a distal end 102 that engages the valve element 94 and a proximal end 104 that engages a portion of inner support 92. In particular, to facilitate assembly, the inner support 92 includes a cap 106 that releasably couples to the proximal end of the inner support 92. With the cap 106 removed from the inner support 92, the valve element 94 and the biasing member 100 may be positioned within the inner support 92, such as during assembly. When the cap 106 is securely coupled to the inner support 92, the proximal end 104 of the biasing member 100 is captured within an annular groove 108 in the cap 106. In this way, the biasing member 100 biases the valve element 94 toward the valve seat 88 and in the closed position. When a sufficiently high pressure condition is reached in tank 12, the valve element 94 may move against the bias of the biasing member 100 and away from the valve seat 88 to open the mechanical valve mechanism 32.

The cap 106 may have a ring configuration with a central aperture 110 therein that maintains an open central passage 42 for effective fluid communication with atmosphere. In addition, to releasably couple the cap 106 to the proximal end of the inner support 92, the cap 106 may include a plurality of radially extending tabs 112 along an outer surface thereof and the proximal end of the inner support 92 may include a plurality of J-shaped slots 114. The tabs 112 and slots 114 operate as a bayonet-type of lock that secures the cap 106 to the inner support 92.

While embodiments of the invention described herein bias the valve element 94 toward the valve seat 88 using a biasing member 100 configured as a coil spring, those of ordinary skill in the art will recognize that other biasing means may be used. For example, other resilient elements, such as a bellows, etc., may be used to bias the valve element 94. Alternately, the valve element 94 may be appropriately weighted so as to prevent movement of the valve element 94 away from the valve seat 88 until a high pressure condition is reached in tank 12. Such a weighted valve element is shown and described in U.S. Provisional Application 60/749,912, the disclosure of which is incorporated by reference herein in its entirety.

The mechanical valve mechanism 32 is configured so that the valve element 94 is engaged with the valve seat 88 for relatively low pressure conditions within tank 12. In this way, any necessary low pressure venting is accomplished via the electronic valve mechanism 30 as described above. In certain emergency situations, such as during refilling operations when fuel vapor is not removed from the tank 12, the pressure within the tank 12 can get relatively high. Under these conditions, high pressure venting may be desired or mandated by regulations.

Accordingly, when the pressure in the tank 12 reaches a specified high pressure relative to the atmosphere, such as a design pressure differential of between about ten inches of water column pressure and about twenty-six inches of water column pressure or higher (e.g., up to about 2 psi as a maximum relief pressure), the valve element 94 may be configured to separate from the valve seat 88 thereby allowing venting from the tank 12 and reducing or equalizing the pressure in tank 12. By way of example, in one embodiment, the biasing element 100 may be configured such that the valve element 94 separates from the valve seat 88 for a design pressure differential of about fourteen inches of water column pressure. In another embodiment (not shown), the valve element 94 may be configured such that the weight of the valve element 94 is overcome at a pressure of about fourteen inches of water column pressure to cause separation of the valve element 94 from the valve seat 88. In such an embodiment, the weight of the valve element may be adjusted so as to separate from the valve seat 88 at a design pressure differential between about ten inches of water column pressure and about twenty-six inches of water column pressure or higher. In either embodiment, if the pressure in the tank 12 rapidly increases, the mechanical valve mechanism 32 opens and high pressure venting from the tank 12 takes place.

In addition, the mechanical valve mechanism 32 may be configured such that at a specified pressure differential, e.g., about 2 psi, a certain volume flow rate may be achieved through the vent valve 28. For example, the diameter of the valve seat 88 and the valve element 94 may be selected to provide the necessary volume flow rate. Those of ordinary skill in the art will recognize other ways to vary the volume flow rate flowing through the mechanical valve mechanism 32 when opened at the specified pressure differential. For example, the biasing member 100 may be configured so that valve element 94 separates from the valve seat 88 by a certain length at the specified pressure differential to achieve the desired volume flow rate. Thus, in one embodiment, the mechanical valve mechanism 32 permits a volume flow rate of about 7,000 cubic feet of gas or vapor per hour to be passed when the valve element 94 is separated from the valve seat 88 at a pressure differential of about 2 psi.

While the movement of the valve element 94 away from the valve seat 88 provides high pressure venting under positive pressure conditions, the mechanical valve mechanism 32 may further provide for high pressure venting under negative pressure conditions as well. To this end and as shown in the figures, the mechanical valve mechanism 32 may include a poppet valve 116 similar to that described in U.S. Publication No. 2004/0074538. The poppet valve 116 includes a valve element 118, such as a disc-shaped piston, positioned on the distal side of valve element 94 and a valve stem 120 extending from a proximal face of the valve element 118 and through an aperture 122 in valve element 94. The valve element 118 is movable between an open position wherein fluid may flow through the poppet valve 116, and a closed position wherein fluid is prevented from flowing through the poppet valve 116. In the closed position, a proximal face of the valve element 118 engages a distal face of valve element 94. Accordingly, at least one of the opposed faces may include a seal 117. The poppet valve 116 is configured to be in the closed position until a high negative or vacuum pressure condition is reached inside tank 12. During emergency situations when a high negative pressure condition may be encountered, the valve element 118 is separated or moved away from the valve element 94 to allow fluid to readily move through the poppet valve 116.

To prevent the poppet valve 116 from moving to the open position during low pressure venting, the valve element 118 may be biased toward the valve element 94 by a biasing member 124, such as a coil spring. As shown in FIG. 5, the biasing member 124 includes a distal end 126 that engages a proximal face of valve element 94 and a proximal end 128 that engages an enlarged portion 130 on valve stem 120. For example, the enlarged portion 130 may include a removable nut threaded onto the end of valve stem 120. In this way, the biasing member 124 biases the valve element 118 toward the valve element 94 and in the closed position. When a sufficiently high negative pressure condition is reached in the tank 12, the valve element 118 may move against the bias of the biasing member 124 and away from valve element 94 to open the poppet valve 116. By way of example, the valve element 118 may move away from valve element 94 to open the poppet valve 116 at a pressure differential between about fifteen inches of water column pressure and about twenty-six inches of water column pressure or higher.

The poppet valve 116 is configured so that the valve element 118 is engaged with the valve element 94, i.e., closed, for relatively low negative pressure conditions within tank 12. In this way, any necessary low pressure venting is accomplished via the electronic valve mechanism 30 as described above. In certain emergency situations, the pressure in the tank 12 can get relatively low (i.e., high vacuum pressures). Under these conditions, high pressure venting may be desired or mandated by regulations. The poppet valve 116 as described above may achieve such high negative pressure venting.

As recognized by those of ordinary skill in the art, the biasing member 124 may include other resilient members and is not limited to a coil spring. Additionally, the poppet valve 116 may be designed to open at a desired negative pressure differential. Moreover, the poppet valve 116 may be designed to achieve a certain volumetric flow rate at the design negative pressure differential in a manner similar to that described above.

The mechanical valve mechanism 32 described above allows for high pressure venting from the PV vent valve 28 during, for example, an emergency situation when relatively high pressure differentials exist within the tank 12 relative to atmosphere. During low pressure venting, however, the mechanical valve mechanism 32 remains closed and any venting is via the electronic valve mechanism 30 as described above. Using two separate valve mechanisms in this manner to accomplish the high and low pressure venting allows for more precise and reliable venting from the tank 12.

The remaining aspects of the proximal portion 36 of housing 34 is similar to that described in U.S. Publication No. 2004/0074538 and includes a filter 132, such as a generally mesh screen filter, sized to fit over and enclose the inner support 92. The filter 132 provides filtering of the gas or vapor exiting the PV vent valve 28 from the tank 12 and vent line 22 or the air entering the PV vent valve 28 from the atmosphere. The proximal portion 36 and filter 132 are configured such that substantially all of the fluid passing through the PV vent valve 28 passes through filter 132. Furthermore, the fluid that passes through valve 72 during the low pressure venting may be routed through the proximal portion 36 of housing 34 to gain the benefit of the filter 132. As noted above, the second port of valve 72 may be in fluid communication with the interior of the enclosure 62. The intermediate portion 38 of housing 34 may in turn include a channel 134 that establishes fluid communication between the interior of the enclosure 62 and the proximal portion 36 of the housing 34. In particular, the channel 134 is configured such that any fluid passing therethrough also passes through the filter 132. Thus, for low pressure positive venting, gas or vapor passes through valve 72, into enclosure 62, through channel 134, through the filter 132 in proximal portion 36, and out to atmosphere. For low pressure negative venting, air passes through filter 132 in proximal portion 36, through channel 134, through valve 72 and into vent pipe 22.

The proximal portion 36 of housing 34 further includes a cap 136 removably coupled thereto to cover the proximal end of the PV vent valve 28. The cap 136 cooperates with the proximal portion 36 of housing 34 to provide a fluid flow path (as illustrated by arrows in FIG. 4 for positive pressure venting) between the interior of proximal portion 36, and thus the central passage 42, and the atmosphere. In particular, the fluid flow path is configured to allow the passage of gases into or out of the PV vent valve 28, but limit or prevent the passage of liquid, such as water from the environment, through the valve 28.

To this end, the cap 136 includes an end portion 140 with a radially extending flange 142 and a distally extending cylindrical portion 144. Extension portion 144 has a cross dimension smaller than the cross dimension of the hub 84 so as to fit within the proximal portion 36 of housing 34 when the cap 136 is coupled thereto. In addition, the extension portion 144 is sized so as to form a gap 146 between the between the cap 136 and hub 84, which forms a part of the fluid flow path. The cap 136 includes a plurality of spaced apart stops 148 on a distal surface of the flange 142. The stops 148 are adapted to engage the proximal end of the proximal portion 36 so that the flange 142 is spaced therefrom to establish and ensure fluid communication between the atmosphere and the gap 146. To limit or prevent the ingress of water into the PV vent valve 28 from the environment, the radial flange 142 has a cross dimension that is greater than the cross dimension of the proximal end of the proximal portion 36, and in this way provide a shield or cover for the fluid flow path. In addition, the proximal portion 36 of housing 34 may include one or more apertures (not shown) at the distal end of proximal portion 36 to operate as drain holes on the occasion that any water does get inside proximal portion 36. These apertures may also provide an alternate fluid flow path to the interior of proximal portion 36.

The cap 136 may be releasably coupled to the proximal end of the PV vent valve 28. In particular, the cap 136 includes at least one connecting member that cooperates with a corresponding connecting member on the housing 34 to removably couple the cap 136 thereto. By way of example, the radial flange 142 of cap 136 may include at least one flexible member 152 extending distally therefrom. The flexible member 152 is biased radially outward and is flexed radially inward against the bias as the cap 132 is coupled to the housing 34. In addition, the proximal portion 36 of housing 34 includes at least one aperture 154 adapted to receive a tab 156 on the terminating end of flexible member 152 such that the flexible member 152 flexes radially outward when the tab 156 engages the aperture 154 to secure the cap 136 to housing 34. The cap 136 may be selectively removed from the housing 34 by pressing the tab 156 radially inward while moving the cap 136 in a proximal direction. In this way, the components of mechanical valve mechanism 32 may be accessed or filter 132 cleaned or replaced without removing the entire PV vent valve 28 from the vent pipe 22.

While the present invention has been illustrated by a description of various preferred embodiments and while these embodiments have been described in some detail, it is not the intention of the inventor to restrict or in any way limit the scope of the appended claims to such detail. Additional advantages and modifications will readily appear to those skilled in the art. The various features of the invention may be used alone or in numerous combinations depending on the needs and preferences of the user.

What is claimed is:

1. A vent valve for a fuel tank, comprising:
a valve housing having a first end adapted to be in fluid communication with the fuel tank and a second end adapted to be in fluid communication with atmosphere, the valve housing defining a central passage extending between the first and second ends; and
an electronic valve mechanism coupled to the housing and in fluid communication with the fuel tank, the electronic valve mechanism including an electronic valve movable between an open position wherein fluid is permitted to flow through the electronic valve and a closed position wherein fluid is prevented from flowing through the electronic valve,
wherein the electronic valve is adapted to open at a design pressure differential between the pressure in the fuel tank and atmospheric pressure so as to reduce the pressure differential therebetween.

2. The vent valve of claim 1, wherein the design pressure differential is one of a positive pressure differential or a negative pressure differential.

3. The vent valve of claim 1, wherein the electronic valve is a solenoid valve.

4. The vent valve of claim 1, wherein the electronic valve mechanism further comprises:
a controller operatively coupled to the electronic valve for controlling the movement of the electronic valve between the open and closed positions.

5. The vent valve of claim 4, wherein the electronic valve mechanism further comprises:
a pressure sensor in fluid communication with the fuel tank and operatively coupled to the controller, the pressure sensor capable of generating a signal indicative of the pressure in the fuel tank, and the controller moving the electronic valve in response to the design pressure differential between the pressure in the fuel tank and the atmospheric pressure.

6. The vent valve of claim 5, wherein the pressure sensor is a pressure transducer.

7. The vent valve of claim 1, wherein the electronic valve is configured to move to the open position when power to the valve is interrupted.

8. The vent valve of claim 1, wherein the design pressure differential at which the electronic valve opens is between about two and one-half inches of water column pressure and about six inches of water column pressure for positive pressure differentials.

9. The vent valve of claim 1, wherein the design pressure differential at which the valve opens is between about six inches of water column pressure and about ten inches of water column pressure for negative pressure differentials.

10. A vent valve for a fuel tank, comprising:
a valve housing;
a first electrical valve mechanism coupled to the valve housing and movable between an open position wherein fluid is permitted to flow through the first valve mechanism and a closed position wherein fluid is prevented from flowing through the first valve mechanism, the first valve mechanism adapted to open and vent the fuel tank for a first design pressure differential between the pressure in the fuel tank and atmospheric pressure; and
a second valve mechanism coupled to the valve housing and movable between an open position wherein fluid is permitted to flow through the second valve mechanism and a closed position wherein fluid is prevented from flowing through the second valve mechanism, the second valve mechanism adapted to remain closed at the first design pressure differential that actuates the first valve mechanism, the second valve mechanism further adapted to open and vent the fuel tank for a second design pressure differential between the pressure in the fuel tank and atmospheric pressure that is greater than the first design pressure differential.

11. The vent valve of claim 10, wherein the first valve mechanism comprises:
an electronic valve in fluid communication with the fuel tank and atmosphere and movable between the open and closed positions;
a pressure sensor in fluid communication with the fuel tank and capable of generating a signal indicative of the pressure in the fuel tank; and
a controller operatively coupled to the electronic valve and the pressure sensor, the controller adapted to control the movement of the electronic valve between the open and closed positions in response to the first design pressure differential.

12. The vent valve of claim 11, wherein the electronic valve is a solenoid valve.

13. The vent valve of claim 11, wherein the pressure sensor is a pressure transducer.

14. The vent valve of claim 11, wherein the electronic valve is configured to move to the open position when power to the valve is interrupted.

15. The vent valve of claim 10, wherein the first design pressure differential at which the first valve mechanism opens is between about two and one-half inches of water column pressure and about six inches of water column pressure for positive pressure differentials.

16. The vent valve of claim 10, wherein the first design pressure differential at which the first valve mechanism opens is between about six inches of water column pressure and about ten inches of water column pressure for negative pressure differentials.

17. The vent valve of claim 10, wherein the second valve mechanism is a mechanical valve mechanism.

18. The vent valve of claim 10, wherein the second design pressure differential is one of a positive pressure differential or a negative pressure differential.

19. The vent valve of claim 10, wherein the second design pressure differential at which the second valve mechanism opens is greater than about ten inches of water column pressure for positive pressure differentials.

20. The vent valve of claim 10, wherein the second design pressure differential at which the second valve mechanism opens is greater than about fifteen inches of water column pressure for negative pressure differentials.

21. A method of venting a fuel tank, comprising:
detecting a pressure indicative of the pressure in the fuel tank;
electronically comparing the detected pressure to a reference pressure; and
opening a valve to establish fluid communication between the fuel tank and atmosphere in response to a pre-selected pressure differential between the detected pressure and the reference pressure as recognized by the comparing step.

22. The method of claim 21, wherein detecting a pressure further comprises using a pressure sensor to detect the pressure.

23. The method of claim 21, wherein electronically comparing comprises using a controller to compare the detected pressure to the reference pressure.

24. The method of claim 21, wherein the reference pressure is atmospheric pressure.

25. A method of venting a fuel tank, comprising:
opening a first electronic valve mechanism to establish fluid communication between the fuel tank and the atmosphere for a first design pressure differential between the pressure in the fuel tank and atmospheric pressure; and
opening a second valve mechanism to establish fluid communication between the fuel tank and the atmosphere for a second design pressure differential greater than the first design pressure differential.
